(19) United States
(12) Patent Application Publication
(10) Pub. No.: US 2022/0277684 A1
(43) Pub. Date: Sep. 1, 2022

(54) SCAN LINE REFRESH FOR MODULAR DISPLAY SYSTEMS

(71) Applicant: LIGHT FIELD LAB, INC., San Jose, CA (US)

(72) Inventors: Jonathan Sean Karafin, San Jose, CA (US); Trevor Berninger, San Jose, CA (US); Brendan Elwood Bevensee, San Jose, CA (US)

(21) Appl. No.: 17/612,887

(22) PCT Filed: May 20, 2020
(86) PCT No.: PCT/US2020/033868

§ 371 Date: Dec. 13, 2021

Related U.S. Application Data
(60) Provisional application No. 62/850,375, filed on May 20, 2019.

(51) Int. Cl. G09G 3/20

(52) U.S. Cl. CPC G09G 3/2092; G09G 2300/026; G09G 2310/062; G09G 2310/0205; G09G 2310/0213

(57) ABSTRACT

In modular video display systems, such as video wall systems, it is common to tile many separate display modules together to form a single display surface which has faint or unnoticeable seams. In such systems, the full resolution video signal is usually split into portions that correspond to the display tiles, and each portion of the video is shown on a different display tile. A uniform scan refresh method may be used for every tile, leading to the neighboring scan lines across some tile boundaries to be updated at different times. This effect, which may cause a temporal artifact for viewers of the video, can be greatly reduced by refreshing scan lines in alternate rows or columns of the display tiles in opposite directions, leading to scan lines across boundaries between tiles being updated at the same time.

### SUMMARY

An embodiment of a video display system of the present disclosure may include an array of more than one display tiles, with the full resolution of the display divided among the display tiles, and wherein the array of display tiles is comprised of one or more columns in the horizontal direction, and more than one row in the vertical direction, and wherein each display tile is updated by refreshing horizontal scan lines, and wherein there exists at least two neighboring rows of display tiles comprised of a first top row and a second bottom row, and horizontal scan lines are updated from top-to-bottom on the display tiles in the first top row, and horizontal scan lines are updated from bottom-to-top on the display tiles in the second bottom row.

An embodiment of a video display system of the present disclosure may include an array of more than one display tiles, with the full resolution of the display divided among the display tiles, and wherein the array of display tiles is comprised of one or more columns in the horizontal direction, and more than one row in the vertical direction, and wherein each display tile is updated by refreshing horizontal scan lines, and wherein neighboring horizontal scan lines on either side of a horizontal seam between neighboring display tiles are refreshed at substantially the same time.

An embodiment of a video display system of the present disclosure may include an array of more than one display tiles, with the full resolution of the display divided among the display tiles, and wherein the array of display tiles is comprised of more than one column in the horizontal direction, and one or more rows in the vertical direction, and wherein each display tile is updated by refreshing vertical scan lines, and wherein there exists at least two neighboring columns of display tiles comprised of a first left column and a second right column wherein vertical scan lines are updated from left-to-right on the display tiles in the first left column, and vertical scan lines are updated from right-to-left on the display tiles in the second right column.

An embodiment of a video display system of the present disclosure may include an array of more than one display tiles, with the full resolution of the display divided among the display tiles, and wherein the array of display tiles is comprised of more than one column in the horizontal direction, and one or more rows in the vertical direction, and wherein each display tile is updated by refreshing vertical scan lines, and wherein neighboring vertical scan lines on either side of a vertical seam between neighboring display tiles are refreshed at substantially the same time.

### BRIEF DESCRIPTION OF THE DRAWINGS

FIG. 1A shows an orthogonal view of a display being updated mid-frame, with horizontal scan lines and a top-to-bottom scan line update sequence.

FIG. 1B shows an orthogonal view of a display being updated mid-frame, with horizontal scan lines which are updated from left to right, but starting at the bottom of the display rather than the top of the display.

FIG. 2A is an orthogonal view of a two-display system at four specific times, showing an update from an all-white frame to an all-gray frame, wherein each display's raster scan sequence is identical.

FIG. 2B is an orthogonal view of a two-display system shown at four specific times, showing an update from an all-white frame to an all-gray frame, in which the two displays are updated with horizontal scan lines using an embodiment of a butterfly scan sequence.

FIG. 3 is an orthogonal view of a two-display system at four specific times, showing an update from an all-white frame to an all-gray frame, in which the two displays are updated with vertical scan lines using an embodiment of a butterfly scan sequence.

FIG. 4A is an orthogonal view of a display system comprised of a 6×3 array of display tiles at four specific times, showing an update from an all-white frame to an all-gray frame, in which the displays are updated with vertical scan lines using a uniform scan line update direction for every display.

FIG. 4B is an orthogonal view of a display system comprised of a 6×3 array of display tiles at four specific times, showing an update from an all-white frame to an all-gray frame, in which the displays are updated with vertical scan lines using an embodiment of a butterfly scan method.

### DETAILED DESCRIPTION

Modular tiled displays which have faint or unnoticable seams between tiles may be built to have a resolution that is as high as desired. These have applications within the video wall market, where large modular two-dimensional displays may be built for custom dimensions, as well as viewing distance and resolution requirements. Light field display systems, which may require a resolution that exceeds what can be achieved on any single display substrate for specifications of large resolutions, large projection distances, and large field-of-view requirements, may also use modular tiled display surfaces. Such light field display systems may use waveguides disposed close to the display surface to project the energy from specific locations on the aggregate display surface into light rays that propagate in three dimensions, toward convergence points with other rays of light to form the surfaces of holographic objects.

In some cases, a video signal contains pixel data that are scanned into a display in a time-sequential pattern. The video display panel refreshes a new image from this sequence using the process of raster scanning, wherein pixels are updated one after the other rather than all at the same time, with all the pixels on the display panel updated over the course of one frame. This can be done by scanning each row of pixels (may also be referred to as a scan line in some instances) from left to right, and then scanning the rows from the top row to the bottom row, resulting in a top-to-bottom scan line update direction. The pixel at the end (often the rightmost pixel) of the scan line may be updated a few microseconds after the pixel at the beginning of the scan line (often the leftmost pixel), and the bottom scan line row may be updated milliseconds after the top scan line row. The refresh time for all the scan lines may be under the period corresponding to the frame rate (e.g. 1/60^{th} of a second, or 16.67 milliseconds for a 60 frame-per-second video signal). It is possible to have vertical scan lines instead of horizontal ones, in which pixels are updated in columns, or scans in which pairs of pixels are updated in opposite directions. These variations are also covered by this disclosure.

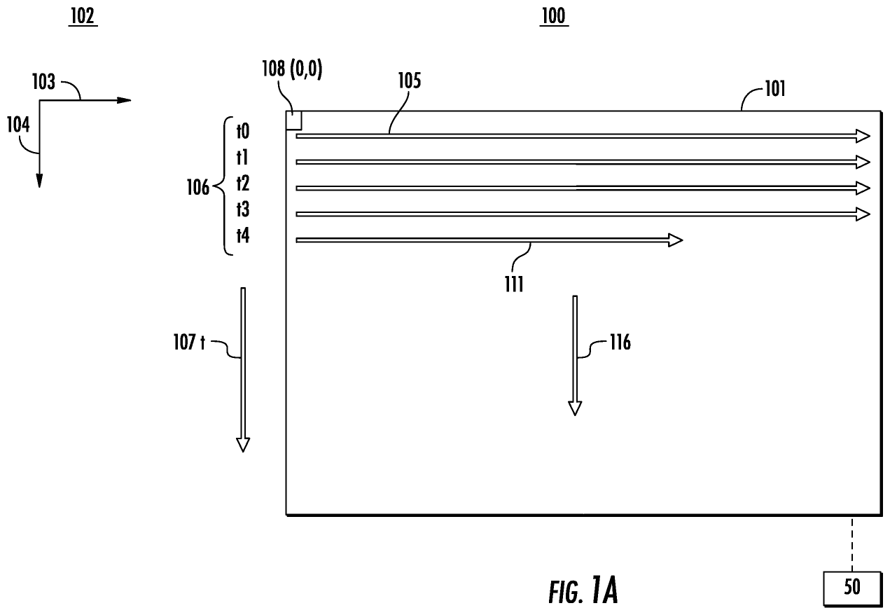

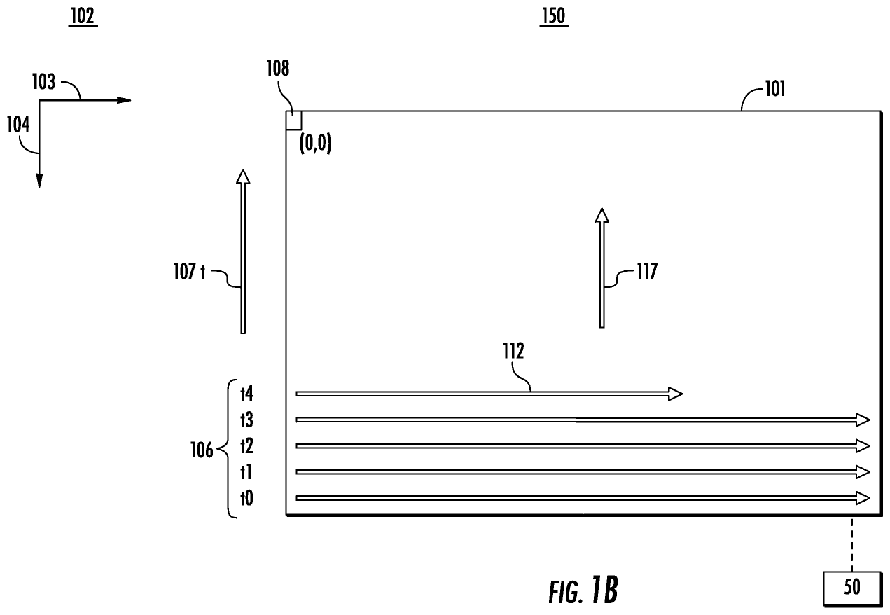

FIG. 1A shows an orthogonal view 100 of a display being updated mid-frame, with horizontal scan lines and a top-to-bottom scan line update sequence. Display 101 has horizontal scan lines 105 which are drawn starting from the top left corner at pixel (0, 0) 108 at time 108 t0, in the direction of the horizontal axis 103 from left to right. Each successive scan line is drawn at a later time 106 t0-t4, in a vertical direction of increasing time 107. This means that the scan line update direction 116 is top-to-bottom of the display. At the moment depicted in 100, the scan line at time t4 is being updated. At least once per update period (inverse of frames per second), all scan lines of the display are refreshed in sequence from the top to the bottom of the display in the vertical direction 104.

While FIG. 1A depicts a top-to-bottom scan sequence, with updates from the left to the right, it is possible that the horizontal scan lines are updated from right to left, or from the bottom of the display to the top of the display, or any combination of these possibilities. FIG. 1B shows an orthogonal view 150 of a display being updated mid-frame, with horizontal scan lines 106 which are updated from left to right, but starting at the bottom of the display 101, rather than the top of display 101. In FIG. 1B, the scan line 112 is being updated at time 106 t4, and the next scan line will be closer to the top of the display where pixel (0,0) 108 resides. The scan line update direction depicted in FIG. 1B is in the bottom-to-top direction shown by the arrow 117.

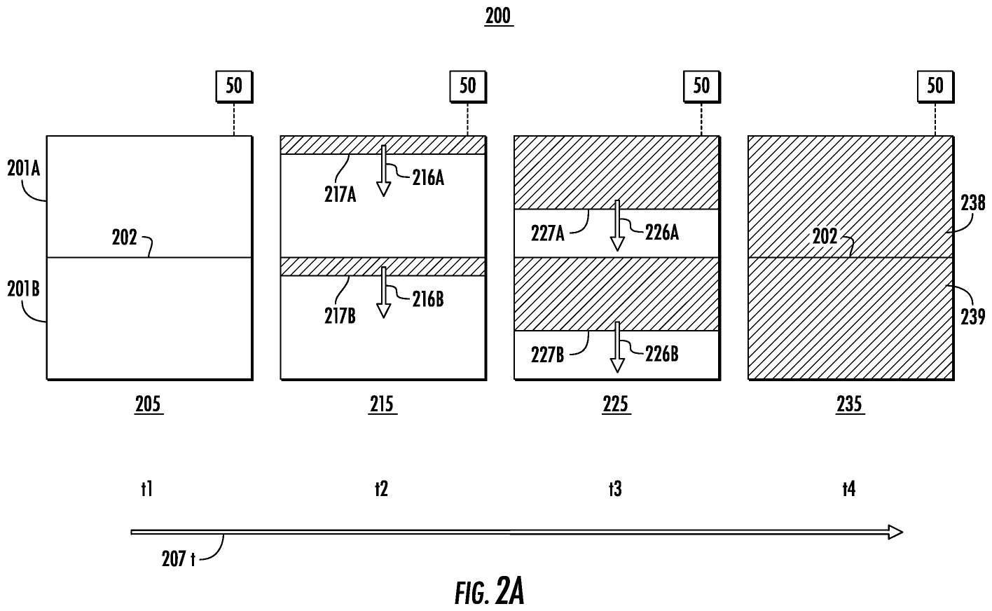

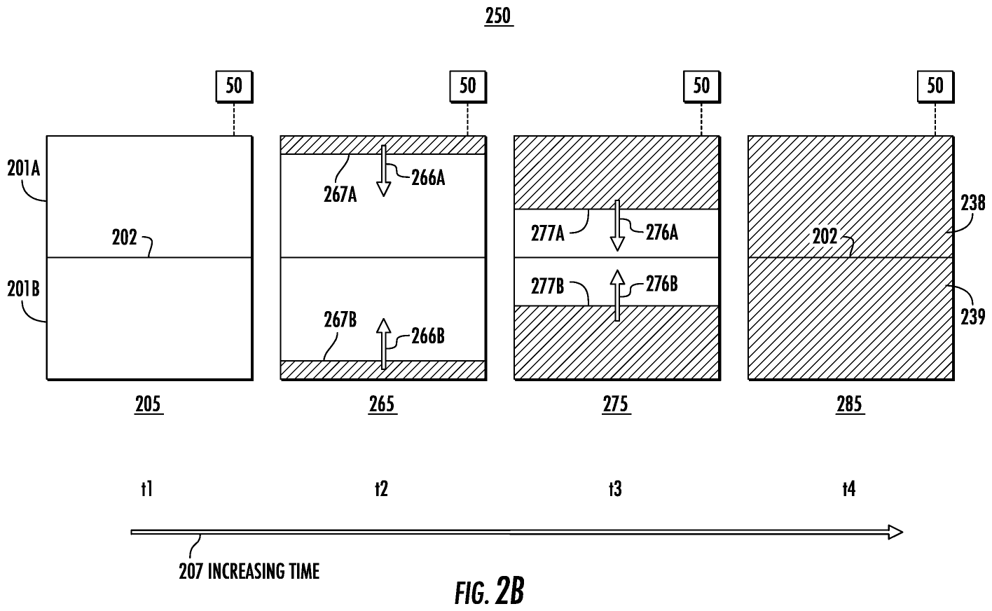

Consider a display system consisting of two separate displays which are joined on a seam line, one directly over another. Such an arrangement may be found on a portion of a video wall system with two neighboring modules, in a venue with two displays which may or may not include bezels, or on a portion of a light field display which may be comprised of many display tiles that are joined together to form a single display surface having seams which are faint or not detectable. FIG. 2A is an orthogonal view 200 of a two-display system at four specific times, showing an update from an all-white frame to an all-gray frame, wherein each display's raster scan sequence is identical. Four views of the same two-display system are shown in a sequence of increasing time 207 at the times t1-t4. Display 201A is disposed over display 201B, with a common seam 202 between the two panels, which may or may not be detectable, and may or may not include a bezel. At time 207 t1, the two-display system has just been updated to show a uniform white frame 205. At time t2, the two-display system has begun to be updated to display an-all gray frame 215. The latest updated scan line on the upper display 201A is 217A, and the scan direction 216A is from the top to the bottom of the display. The latest updated scan line on the lower display 201B is 217B, and the scan direction 216B is also from the top to the bottom of the display. At a later time t3, near the middle of the update of the gray frame 225, the current refreshed scan line has advanced to 227A on the upper display 201A and 227B on the lower display 201B, at similar positions for each display. At time 207 t3, the scan direction continues along the downward direction of 226A on the upper display 201A and the same downward direction 226B on the lower display 201B. At t4, all scan lines of both displays have been updated, which occurs as the refresh of the display for the gray frame 235 has been completed.

With this uniform scan direction for both displays, neighboring locations near the seam 202 between the panels are updated at different times. The bottom of the top display 201A near the seam 202 at location 238 gets refreshed as the last updated scan line, while the top of the bottom display 201B near seam 202 at location 239 gets refreshed as the first updated scan line. The difference in time for refreshing these two neighboring scan line locations may be roughly equal to the time between frames (e.g. 16.67 ms for a 60 Hz video signal, minus a small amount of time for a blanking interval). This means that at this seam boundary 202, there may be a noticeable timing artifact due to this time delay, depending on the content being shown.

Also notice that as the two-display system is being updated to show the grey frame, for example at t2 near the beginning of the grey frame, or at t3 near the middle of the gray frame, there are two different regions on the two-display system which are white, and two different regions on the display system which have been updated to gray, and these regions are interleaved. These regions represent a timing difference of one frame. In addition, notice that the regions of timing discontinuity near the end of the frame, at 3 or later, occur only near the seam 202 between the two display panels, which may make the seam 202 more obvious, particularly if the two display tiles have a slight spatial separation, slight color differences, or other imperfections in the vicinity of the seams. For a light field display system, where waveguides may project the light from different locations on the display surface in different directions depending on the location, more regions of discontinuity in timing may result in more noticeable temporal video artifacts.

An embodiment of the present disclosure comprises a method for changing the scan direction on one of the displays so that the two-display system updates neighboring scan lines located on a border between two displays at the same time, or substantially the same time, and the number of regions representing one-frame delays are reduced. In this disclosure, this is called a butterfly scan sequence. FIG. 2B is an orthogonal view 250 of a two-display system shown at four specific times, showing an update from an all-white frame to an all-gray frame, in which the two displays are updated with horizontal scan lines using an embodiment of a butterfly scan sequence.

In the embodiment depicted in FIG. 2B, Display 201A is disposed over display 201B, with a common seam 202 between the two panels, which may or may not be detectable, and may or may not include a bezel. At time 207 t1, the two-display system has just been updated to show a uniform white frame 205. At time t2, the two-display system has begun to be updated to display an-all gray frame 265. In the embodiment depicted in FIG. 2B, the current (latest updated) scan line on the upper display 201A is 267A, and the scan line update direction 266A is from the top to the bottom of the display. In the embodiment depicted in FIG. 2B, the current updating scan line on the lower display 201B is 267B, and the scan direction 266B is from the bottom of the display toward the top of the display, which is opposite to the scan direction 266A of the top display 201A. In other words, FIG. 2B depicts an embodiment where the current scan lines on each display move to meet one another at the seam between the displays 202. In some embodiments, at a later time t3, near the middle of the update of the gray frame 275, the scan line has advanced to 277A on the upper display 201A and 277B on the lower display 201B, and the scan direction continues along the downward direction of 276A on the upper display 201A and the upward direction 276B on the lower display 201B. At t4, all scan lines of both displays have been updated at the end of the refresh of the gray frame 285.

In some embodiments, with this butterfly scan sequence for both displays, neighboring scan line locations near the seam 202 between the panels are updated at the same time, or substantially the same time. The bottom of the top display 201A near the seam 202 at location 238 gets refreshed as the last updated scan line, while the top of the bottom display 201B near seam 202 at location 239 also gets refreshed at about the same time. In some embodiments, this means that at seam boundary 202, there may be no noticeable timing artifact due to this time delay. Also notice that in some embodiments like the one depicted in FIG. 2B, as the two-display system is being updated to show the gray frame, for example at t2 near the beginning of the gray frame, or at t3 near the middle of the gray frame, there are two different regions on the display system which are gray, and only one region on the display system which is still white, as opposed to the four interleaved regions shown at t2 and t3 in FIG. 2A. These regions can represent a timing difference of one frame. This means that the middle white region of the display depicted in FIG. 2B, which represents a frame period time delay, gradually becomes smaller as the two updating scan lines from the top and bottom displays meet. This also means that, in the embodiment depicted in FIG. 2B, the region in the vicinity of the seam 202 between the top and bottom displays is updated temporally at the same time, which may make the seam line 202 less noticeable than using the uniform scan sequence shown in FIG. 2A. For a light field display system, where waveguides may project the light from different locations on the display surface in different directions depending on the location, fewer regions of discontinuity in timing may result in less noticeable temporal video artifacts.

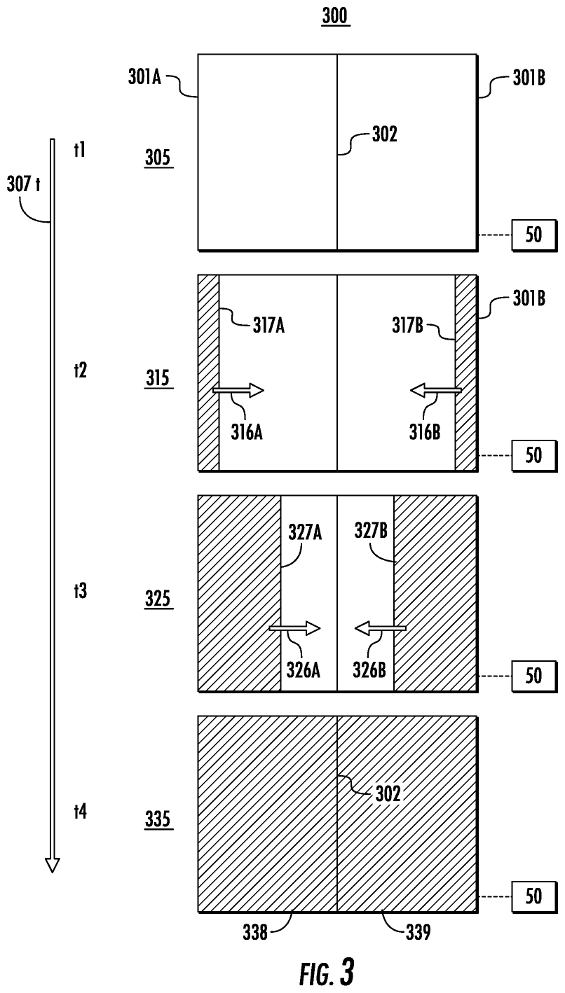

Embodiments of the butterfly scan sequence can be used for displays where the scan lines are vertical, rather than horizontal. One such embodiment is depicted in FIG. 3. FIG. 3 is an orthogonal view 300 of a two-display system at four specific times, showing an update from an all-white frame to an all-gray frame, in which the two displays are updated with vertical scan lines using an embodiment of a butterfly scan sequence. Four views of the same two-display system are shown in a sequence of increasing time 307 at the times t1-t4. In the embodiment depicted in FIG. 3, display 301A is disposed to the left of display 301B in a side-to-side configuration with a common vertical seam 302 between the two panels, which may or may not be detectable, and which may or may not include a bezel. At time 307 t1, the two-display system of FIG. 3 has just been updated to show a uniform white frame 305. At time t2, the two-display system of FIG. 3 has begun to be updated to display an-all gray frame 315. The current scan line on the left display 301A is 317A, and the scan direction 316A is from the left to the right of the display in FIG. 3. In the embodiment shown in FIG. 3, the latest updated scan line on the right display 301B is 317B, and the scan direction 316B is from the right to the left of the display, in an opposite direction to the scan direction of the left display 301A. In other words, in embodiments like the one depicted in FIG. 3, the current scan lines on each display move to meet one another at the seam between the displays 302. At a later time t3, near the middle of the update of the gray frame 325, the scan line has advanced to 327A on the left display 301A and 327B on the right display 301B, and the scan direction continues along the left-to-right direction of 326A on the left display 301A and the right-to-left direction 326B on the right display 301B. At t4, all scan lines of both displays have been updated at the end of the refresh of the gray frame 335.

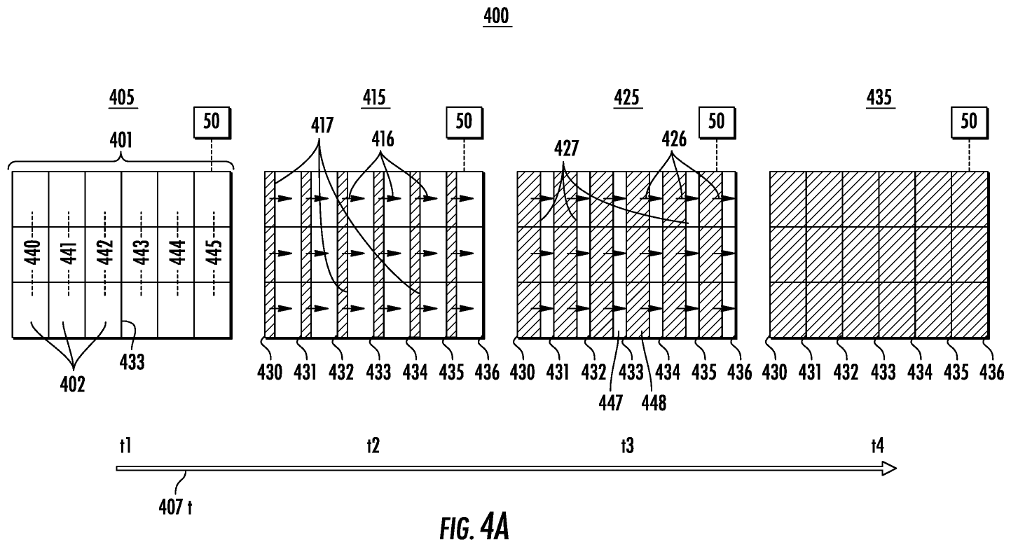

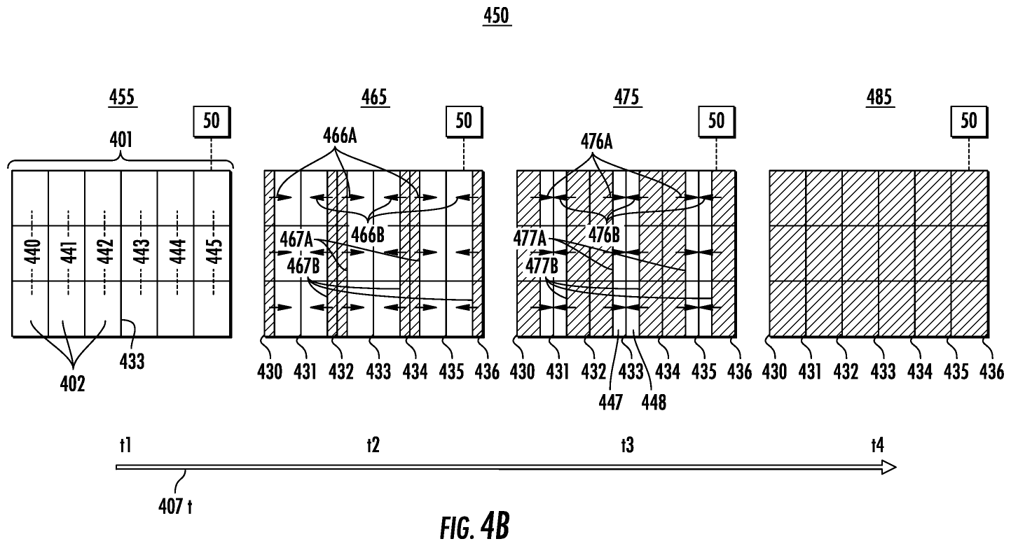

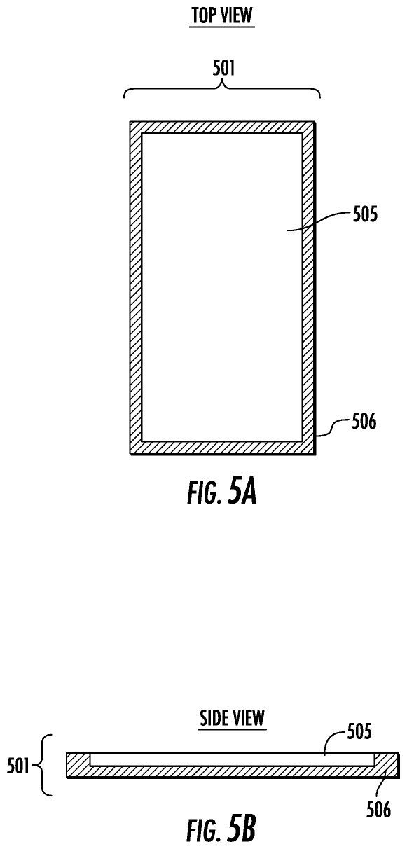

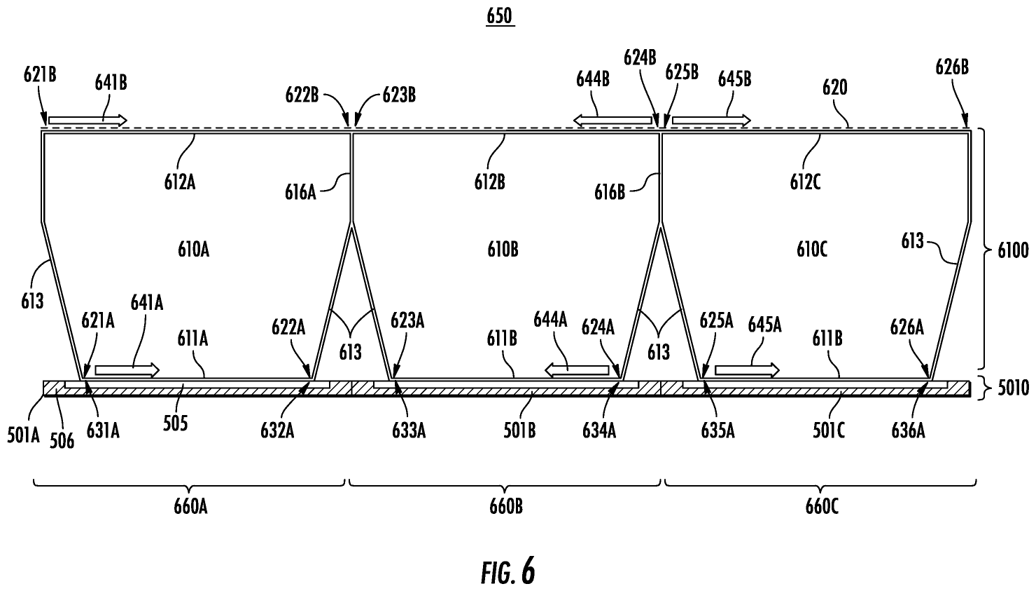

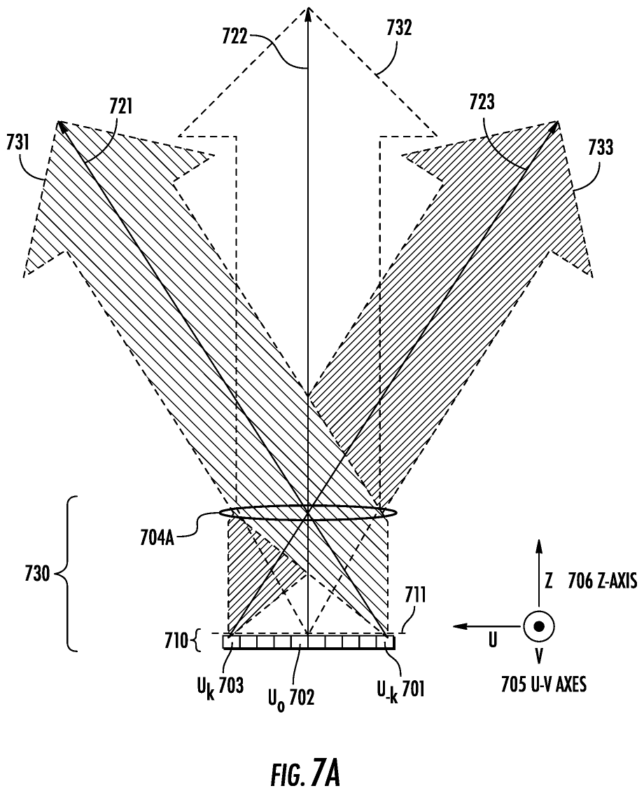

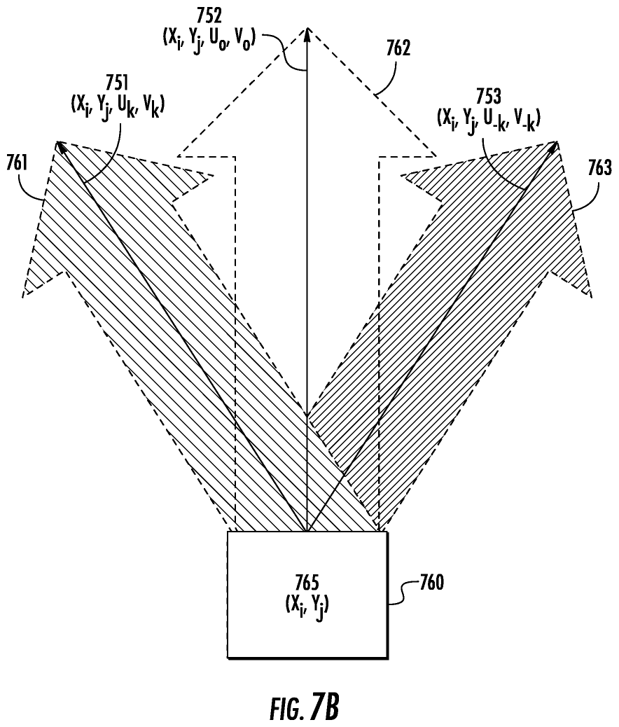

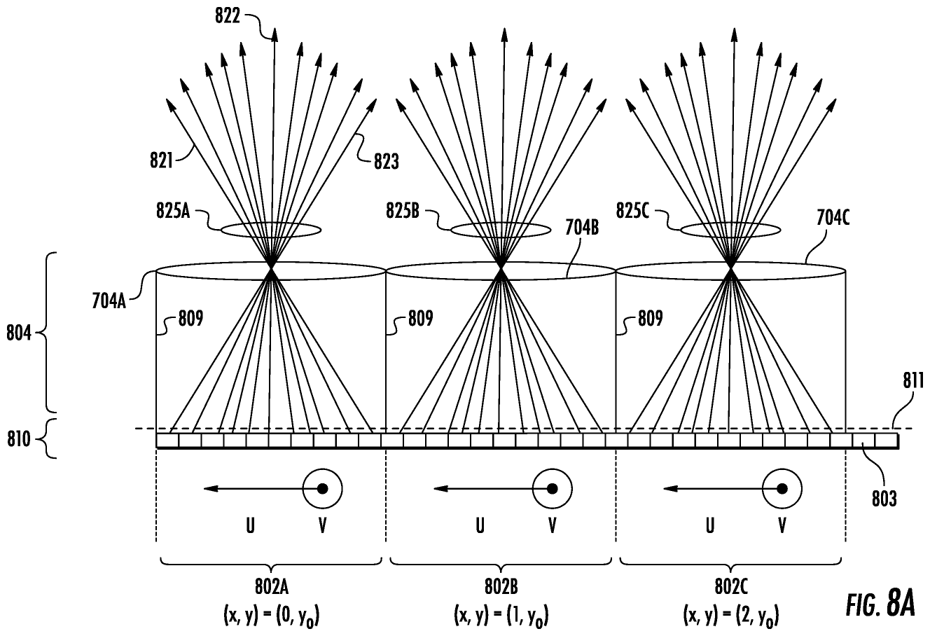

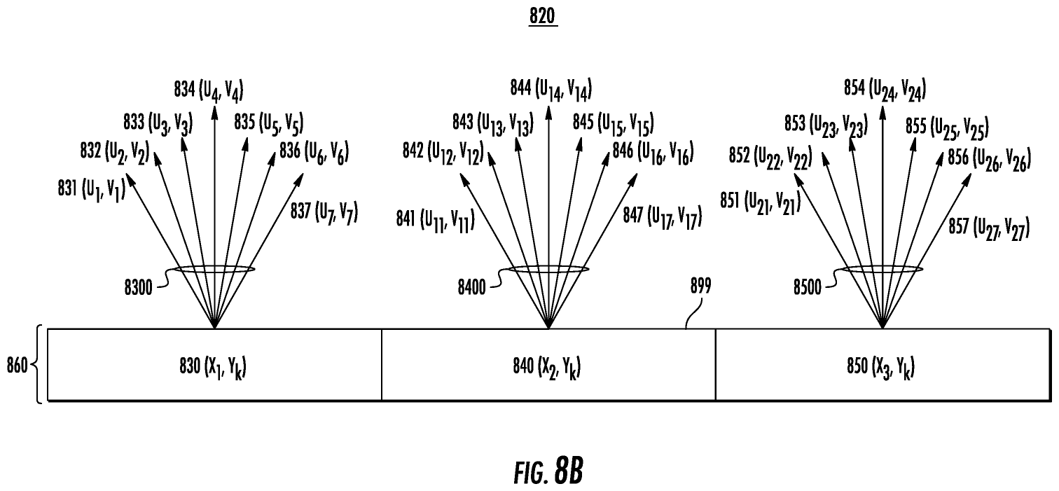

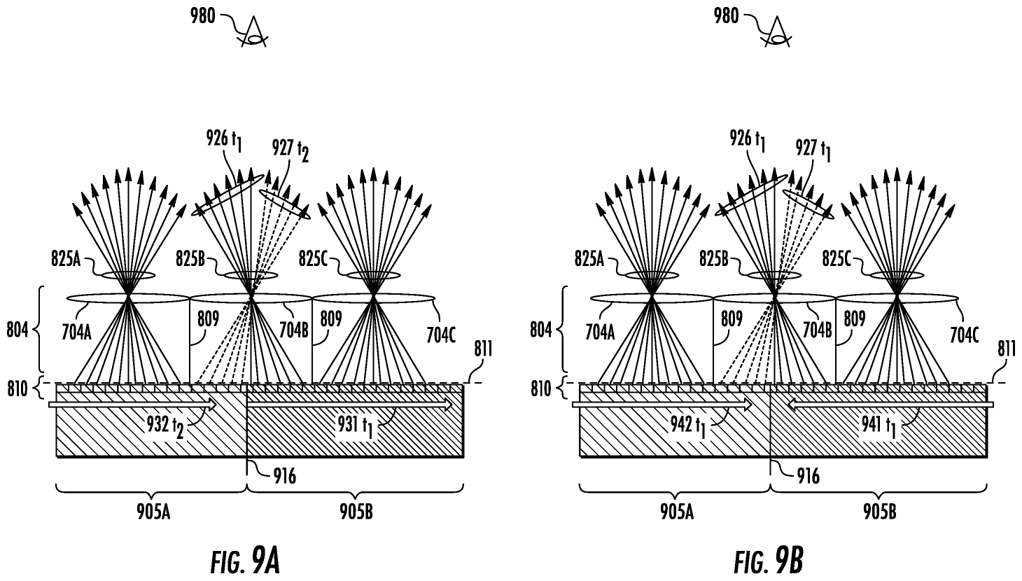

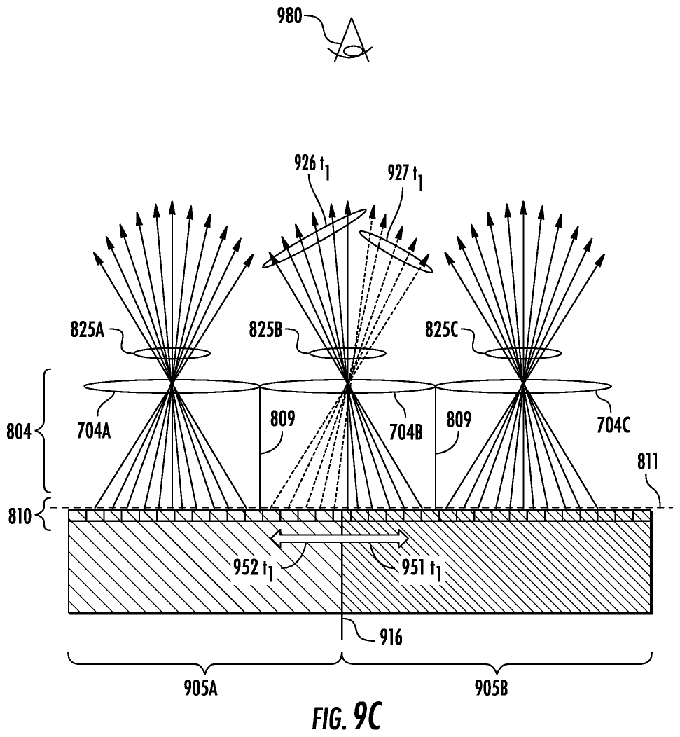

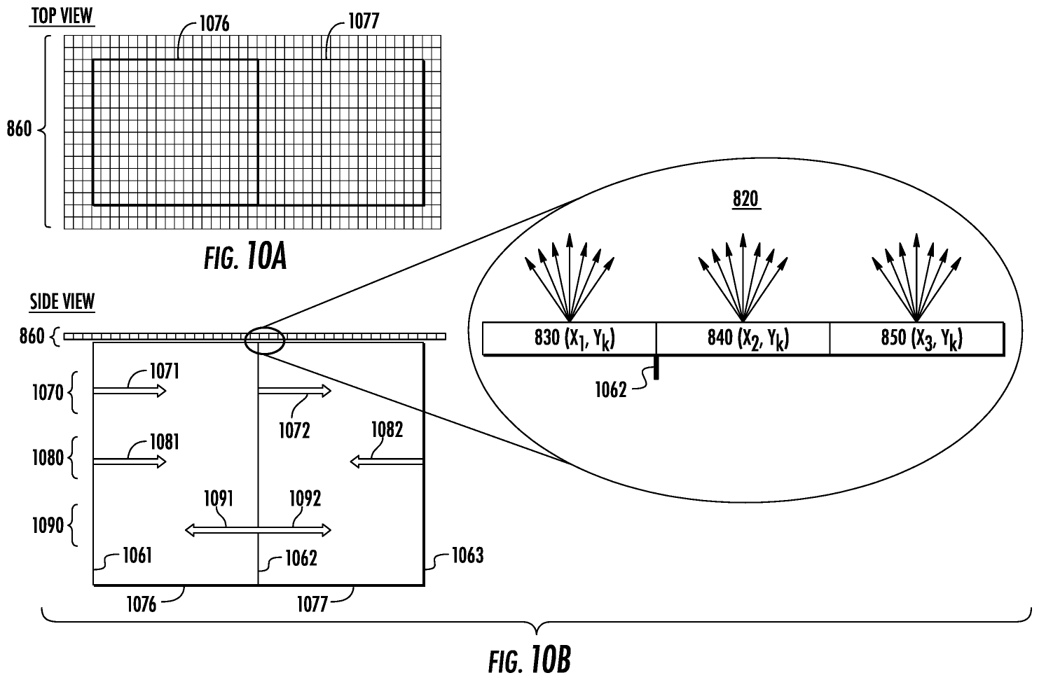

The benefits of the butterfly scan sequence may be amplified when embodiments of the method are applied to an array of display devices which have more than one row or more than one column, or both. FIG. 4A is an orthogonal view 400 of a display system comprised of a 6×3 array of display tiles at four specific times, showing an update from an all-white frame to an all-gray frame, in which the displays are updated with vertical scan lines using a uniform scan line update direction for every display. Four views of the same display system are shown in a sequence of increasing time 407 at the times t1-t4. The 6×3 array 401 contains 18 individual display panels 402, in 6 columns 440-445 each comprised of 3 rows, which are closely spaced with horizontal seam lines as well as vertical seam lines such as 433. At time 407 t1, an-all white frame 405 has just finished being displayed. At time 407 t2, the beginning of the all-gray frame 415 appears, with updated scan lines 417 and uniform left-to-right scan line update directions 416. On each display, the vertical scan lines are drawn first on the left vertical boundaries 430, 431, 432, 433, 434, and 435. At time 407 t3, the gray frame is a little more than half drawn 425. Scan lines 427 are being updated, still in the left-to-right scan line update direction 426. At time 407 t4, the gray frame has been updated at 435.

With this uniform scan direction for every display in the array 401, neighboring vertical scan lines on either side of the vertical seams 431, 432, 433, 434, and 435 are updated at different times, and this time difference can be most of the time period between two frames. For example, scan lines near location 447, on the left of seam line 433, get refreshed at the end of the frame, while scan lines near location 448, on the right of seam line 433, right next to location 447, get refreshed at the beginning of the frame. This means that at this vertical seam boundary 433, there may be a noticeable timing artifact due to this time delay, depending on the content being shown. Also notice that as the display system array is being updated to show the gray frame, for example at t2 near the beginning of the gray frame, or at t3 near the middle of the gray frame, there are 6 different regions on the display system which are white, and 6 different regions on the display system which have been updated to gray, and these regions are interleaved. These regions represent a timing difference of one frame. In addition, notice that the regions of timing discontinuity near the end of the frame at t3 or later, only occur near the seam lines 431, 432, 433, 434, or 435 between two display tile columns. This may make these seams more obvious, particularly if any two display tiles which share a seam have a slight spatial separation, slight color differences, or other imperfections in the vicinity of that seam. For a light field display system, where waveguides may project the light from different locations on the display surface in different directions depending on the location, more regions of discontinuity in timing may result in more noticeable temporal video artifacts.

Using an embodiment of the butterfly scan sequence, in contrast to the uniform scan sequence shown in FIG. 4A, the scan lines near the display boundaries 431, 432, 433, 434, and 435 can be updated all at the same time, and the number of interleaved white and gray regions, representing one-frame temporal differences, can be reduced by about half.

FIG. 4B is an orthogonal view 450 of a display system comprised of a 6×3 array of display tiles at four specific times, showing an update from an all-white frame to an all-gray frame, in which the displays are updated with vertical scan lines using an embodiment of the butterfly scan method. The 6×3 array 401 contains 18 individual display panels 402, in 6 columns 440-445 each comprised of 3 rows, which are closely spaced with horizontal seam lines as well as vertical seam lines such as 433. At time 407 t1, an-all white frame 455 is being displayed in the embodiment depicted in FIG. 4B. At time 407 t2, the beginning of the all-gray frame 465 appears, with left-to-right scan line update directions 466A on even columns 440, 442, and 444 of the display, and right-to-left scan line update directions 466B on odd columns 441, 443, 445. This means that in the embodiment depicted in FIG. 4B, the refreshing vertical scan lines move in opposite directions away from seams 432 and 434, and each scan direction on any display is approaching an opposite scan direction on a neighboring display. In other words, in some embodiments, the current scan lines on each display move to meet one another at the vertical seam lines between the displays 431, 433, and 435. At time 407 t3, the gray frame is a little more than half drawn 475. Scan lines 477A on even columns 440, 442, and 444 continue to be updated in a scan line update direction 476A from left-to-right, while scan lines 477B continue to be updated in an opposite scan direction 476B from the right to the left for odd columns 441, 443, and 445. At time 407 t4, the gray frame has been updated 485.

In embodiments, such as depicted in FIG. 4B, the butterfly scan sequence neighboring scan lines near the vertical seams 431, 432, 433, 434, and 435 between the panels get updated at the same time. For example, scan lines near location 447, on the left of seam line 433, get refreshed at the end of the frame in the embodiment shown in FIG. 4B, as do the scan lines near location 448, on the right of seam line 433, right next to location 447. This means that in the embodiment shown in FIG. 4B, at this vertical seam boundary 433, there will be substantially no timing artifact due to a noticeable time delay. Also notice, in FIG. 4B, that as the display array is being updated to display the gray frame, for example at t2 near the beginning of the gray frame, or at t3 near the middle of the gray frame, there are only three different regions on the display system which are white, as opposed to six such regions in FIG. 4A for the uniform scan sequence, and only four different regions on the display system which have been updated to gray, as opposed to six such regions in FIG. 4A for the uniform scan sequence. The total number of these regions, representing one-frame temporal differences, have been reduced by about half, which means there are fewer places where temporal artifacts may appear by utilizing an embodiment of the butterfly scan sequence. Finally, notice that in embodiments like shown in FIG. 4B, there may be no regions of timing discontinuity near the vertical seams 431, 432, 433, 434, or 435 between columns of the array of display tiles, which helps hide these seams, particularly if neighboring display tiles have a slight spatial separation, slight color differences, or other imperfections in the vicinity of these vertical seams. For a light field display system, where waveguides may project the light from different locations on the display surface in different directions depending on the location, fewer regions of discontinuity in timing may result in less noticeable temporal video artifacts.

FIG. 5A shows a top view of a display device 501 comprised of a display area 505 and a non-imaging bezel 506. FIG. 5B shows a side view of the display device 501 shown in FIG. 5A. The display device 501 may be an emissive display such as an LED, OLED, or micro-LED display, or a transmissive display such as an LCD display. The bezel 506 of the display device 501 does not produce light, and so it prevents multiple display devices 501 from being tiled seamlessly in either a one-dimensional (1D) array or a two-dimensional (2D) array to form a larger display area without obvious seams due to the non-imaging bezel area. To create a seamless energy surface from an array of energy devices with bezels, it is possible to use tapered energy relays.

FIG. 6 shows an orthogonal view of a modular seamless display system 650 comprised of an array 5010 of display devices 501A-C with bezels 506 connected to one end of a corresponding array 6100 of energy relays 610A-C which on the opposite end form a display surface 620 with substantially invisible seams 616A and 616B. The display system 650 in FIG. 6 is comprised of a 1D array of display devices 501A-C and a 1D array of energy relays 610A-C, but the display devices and the energy relays may be arranged in a 2D array, with as many display devices and energy relays as desired. In the configuration shown in FIG. 6, the energy relays 610A, 610B, and 610C are tapered energy relays that are used each to relay the image received from a display area 505 of one of the display devices 501A-C to a common seamless display surface 620 on the opposite side of the relay. Each tapered energy relay 610A-C may relay the image from the corresponding display device 501A-C, respectively, without a substantial loss in spatial resolution or light intensity of the image from the display area 505. Together, a display device 501A bonded to an energy relay 610A forms a relayed display assembly 660A. Similarly, display devices 501B-C bonded to energy relays 610B-C form relayed display assemblies 660B-C, respectively. The large ends 612A-C of each relayed display assembly 660A-C may be bonded together to form a substantially seamless display surface 620. The tapered energy relays 610A-C may be tapered fiber optic relays, tapered glass or polymer material, or some other material, and may be comprised of random distributions of materials, or ordered distributions of materials. The energy relays 610A-C may be comprised of a material such as glass or polymer which contains a random arrangement of materials and relays energy according to the Anderson Localization principle, or they may be comprised of an ordered arrangement of materials such as glass or polymer and relay light according to an Ordered Energy localization effect, which is described in commonly-owned International Publication Nos. WO 2019/140269 and WO 2019/140343, all of which are incorporated herein by reference for all purposes. The tapered relays 610A-C have a small end 611A-C at the display area 505 of the display device 501A-C, respectively, and a magnified end 612A-C, respectively, which contributes to forming the seamless display surface 620. Between these opposite ends, the tapered energy relays 610A-C each may have a sloped section 613. Each energy relay transports energy between the minified end 611A-C and the magnified end 612A-C, respectively, and this energy may be transported in either direction. In the configuration shown in FIG. 6, the energy relays 610A-C may transport energy from first display areas 505 of display devices 501A-C to the second display areas at magnified ends 612A-C, respectively. In this case, wherein the second display area is larger than the first, the tapered energy relays 610A-C provide magnification of the image from the display area 505 of each display device 501A-C, respectively. The seams 616A and 616B between tapered relays in the relay array 6100 may be small enough not to be noticed at any reasonable viewing distance from the seamless display surface 620. While FIG. 6 shows the relay of display areas 505 from three separate display devices 501A-C of the array 5010 being relayed with the three tapered imaging relays 610A-C of the array of tapered relays 6100 to a common display surface 620 with substantially no noticeable seams 616A-B, respectively, it is possible to construct similar combined display planes by relaying many more devices in two orthogonal planes, so that any practical number of display devices, each comprised of a non-imaging bezel, may contribute to an essentially seamless display surface 620. As many display devices as desired may be combined in two dimensions with the method shown in FIG. 6, forming a seamless display surface 620 with as much resolution as required for an application. Multiple display devices 501A-C and corresponding energy relays 610A-C may be arranged this way to create displays of any size, such as the 3×6 arrays of displays shown in FIG. 4A. The full resolution of the seamless energy surface 620 is divided by the area of the large ends 612A-C of the tapered energy relays 610A-C, respectively, wherein each tapered energy relay 610A-C transports the image from a corresponding display device 501A-C, respectively.

In FIG. 6, on the first relayed display unit 660A, a scan line 631A on the left side of display device 501A may illuminate location 621A on the left side of the narrow end 611A of the tapered energy relay 610A, while a scan line 632A on the right side of the display device 501A may illuminate point 622A on the right side of the narrow end 611A of the same tapered energy relay 610A. In turn, the locations 621A and 622A on the narrow end 611A of energy relay 610A may map to points 621B and 622B on the large end 612A, respectively. This means that a group of consecutive scan lines on the display device 501A between scan lines 631A and 632A will map to corresponding scan lines between 621B and 622B on the large end 612A of the tapered energy relay 610A, respectively. The point 621B may be considered a first scan line l_{1,1}, and the point 622B may be considered the n^{th} scan line l_{1,n}, respectively, of the first relayed display assembly 660A comprised of the display device 501A and the tapered energy relay 610A. As shown in FIG. 6, the display device 501A may be configured to scan in direction 641A from left scan line 631A toward right scan line 632A to achieve the mapped relayed scan direction 641B from left point 621B to right point 622B on the large end 612A of the relay 610A, the large end 612A forming a portion of the seamless display surface 620. In another configuration not shown in FIG. 6, the point 621B can be considered the n^{th} scan line, l_{1,n}, and the point 622B may be considered the a first scan line l_{1,1}, respectively, of a first display assembly 660A.

Similarly, on the second relayed display assembly 660B, a scan line 633A on the left side of display device 501B may illuminate point 623A on the left side of the narrow end 611B of the tapered energy relay 610B, while a scan line 634A on the right side of the display device 501B may illuminate point 624A on the right side of the narrow end 611B of the same tapered energy relay 610B. On tapered energy relay 610B, the portion of an image produced by display 501B near points 623A and 624A on the narrow end 611B of the tapered energy relay 610B may be transported to form an image near points 623B and 624B on the large end 612B, respectively. As shown in FIG. 6, the display device 501B may be configured to scan in direction 644A from the left scan line 634A toward right scan line 633A to achieve the mapped relayed scan 644B from right point 624B to left point 623B on the large end 612B of the relay 610B, the large end 612B forming a portion of the seamless display surface 620. As shown in FIG. 6, the point 624B is a first scan line l_{2,1}, and the point 623B is the n^{th} scan line l_{2,n}, respectively, of the second relayed display assembly 660B that is comprised of the display device 501B and the tapered energy relay 610B. In another configuration not shown, the point 623B may be considered the first scan line l_{2,1}, and the point 624B may be considered the n^{th} scan line l_{2,n} of a second display unit 660B.

For the third relayed display assembly 660C, a scan line 635A on the left side of display device 501C may illuminate point 625A on the left side of the narrow end 611C of the tapered energy relay 610C, while a scan line 636A on the right side of the display device 501C may illuminate point 626A on the right side of the narrow end 611C of the same tapered energy relay 610C. On tapered energy relay 610C, the portion of an image produced by display 501C near points 625A and 626A on the narrow end 611C of the tapered energy relay 610C may be transported to form an image near points 625B and 625B on the large end 612C, respectively. As shown in FIG. 6, the display device 501C may be configured to scan 645A from the right scan line 625A toward left scan line 626A to achieve the mapped relayed scan direction 645B from left point 625B to right point 626B on the large end 612C of the relay 610C, the large end 612C forming a portion of the seamless display surface 620. As shown in FIG. 6, the point 625B is a first scan line, and the point 625B is the n^{th} scan line respectively, of the third relayed display assembly 660C that is comprised of the display device 501C and the tapered energy relay 610C. In another configuration not shown, the point 626B may be considered the first scan line, and the point 625B may be considered the n^{th} scan line of the third display unit 660C.

FIG. 6 shows a method of scanning a pair of relayed display assemblies 660A-B with full resolution divided among the display units, the method comprising: updating a first relayed display assembly 660A of the array of display devices in a first update direction 641B beginning at a first scan line l_{1,1} 621B, and ending at an nth scan line l_{1,n} 622B of the first display assembly 660A, updating a second relayed display assembly 660B of the array of display assemblies in a second update direction 644B beginning at a first scan line l_{2,1} 624B, and ending at an nth scan line l_{2,n} 623B of the second display 660B, wherein the first 660A and second 660B display assemblies are adjacent to each other and have a seam 616A therebetween. In this example, the first 641B and second 644B update directions are both defined toward the seam 616A. The pair of relayed display assemblies 660A-B are updated in a manner similar to the first two columns 440 and 441 of display panels in FIG. 4B, where the scans meet at the common boundary seam 431 between these columns. This is part of the butterfly scanning method for display system 650 in FIG. 6.

As discussed above for FIG. 6, for the pair of displays comprised of first relayed display assembly 660B and second display 660C, FIG. 6 shows a method of scanning an array of display units 660B-C with full resolution divided among the display units 660B-C, the method comprising: updating a first display 660B of the array of display assemblies in a first update direction 644B beginning at a first scan line l_{1,1}624B, and ending at an nth scan line l_{1,n} 623B of the first display assembly 660B, updating a second relayed display assembly 660C of the pair of displays in a second update direction 645B beginning at a first scan line l_{2,1} 625B, and ending at an nth scan line l_{2,n} 626B of the second display assembly 660C, wherein the first 660B and second 660C display assemblies are adjacent to each other and have a seam 616B therebetween, and wherein for this example the first and second update directions are both defined away from the seam 616B. The pair of relayed display assemblies 660A-B are updated in a manner similar to the second two columns of display panels 441 and 442 in FIG. 4B, where the scans are updated first at the common boundary seam 432 between these columns, and then away from this boundary seam 432. This contributes to the butterfly scanning method for display system 650.

A four-dimensional (4D) light field display may be constructed from an array of waveguides disposed over an illumination energy source plane of a display surface, with each waveguide projecting the energy from one or more energy sources into projection paths at least in part determined by the location of the illumination energy source relative to the waveguide. FIG. 7A shows a light field display module 730 comprised of a single waveguide 704A placed over an illumination plane 710 which is comprised of individually addressable pixels at coordinates u₋ₖ 701, u₀ 702, and uₖ 703 located on a display surface 711. The seamless display surface 711 may be seamless display surface 620 in FIG. 6, the display area 505 of display device 501 shown in FIG. 5, or some other display surface. The waveguide 704A may be a single lens or a multi-element lens with a focal length equal to the separation between the waveguide 704A and the display surface 711, or some other type of waveguide. The waveguide 704A may receive light from an illumination source pixel such as 701 u₋ₖ on the illumination source plane 710, and project this light into a light ray 731 with a unique direction. Some of the light from the pixel 701 u₋ₖ at the right is received by the waveguide 704A and propagated into energy ray 731 defined by the chief ray propagation path 721, the direction of propagation path 721 determined at least in part by the location of pixel 701 u₋ₖ relative to the waveguide 704A. The energy ray 731 centered on the propagation path 721 may be substantially collimated, may have an area that is a substantial fraction of the area of the waveguide 704A, and may slightly increase in area with distance from the waveguide 704A. Similarly, a portion of the light from the pixel at the right uₖ 703 is received by the waveguide 704A and directed into energy ray 733, which is defined by chief ray propagation path 723, a path that is determined by the location of pixel uₖ 703 relative to waveguide 704A. The light ray 732 centered on chief ray 722 that is normal to the display surface 711 and aligned with the z-axis 706 is provided in this example by the pixel u₀ 702 near the optical axis of the waveguide 704A. The coordinates u₋ₖ, u₀, and uₖ describe both the location of the energy sources 701-703 relative to the waveguide 704A as well as the angular coordinates of corresponding light propagation paths 721-3, respectively, in one dimension called axis u. There is also a corresponding angular coordinate in the orthogonal dimension v. These u-v axes 706 equally describe the location of the pixels 701-703 relative to the waveguide 704A as well as the resulting propagation paths 721-3. In general, the waveguide 704A may be assigned to have a single spatial coordinate in two dimensions (x, y), and energy sources such as 701-703 associated with a waveguide may produce light propagation paths 721-723 each with a two-dimensional angular coordinate (u, v). Together, these 2D spatial coordinates (x, y) and 2D angular coordinates (u, v) form a 4-dimensional (4D) light field coordinate (x, y, u, v) assigned to each propagation path 721-3. The light rays 731-733 centered on light propagation paths 721, 722, and 723 result from the waveguide projecting energy from energy sources 701, 702, and 703, respectively. FIG. 7A shows one implementation of a light field defined by a waveguide over an energy source plane. There are many other architectures possible, for example ones with holographic optical elements, and others comprised of beam-steering devices and collimated light sources that may include lasers and beam expanders.

FIG. 7B shows a light field display module 760 which produces multiple energy propagation paths at a single spatial coordinate 765 (xᵢ, yⱼ). Three energy propagation paths 751-3 defining the direction of energy rays 761-3 are shown to be projected from the light field display module 760 into 4D coordinates (xᵢ, yⱼ, uₖ, vₖ), (xᵢ, yⱼ, u₀, v₀), and (xᵢ, yⱼ, u₋ₖ, v₋ₖ), respectively. A light field display may be built with a plurality of such modules and will be described below. While FIG. 7B shows only three energy propagation paths 751-3, the light field display module 760 may be configured to project any number of propagation paths, each with a 4D coordinate (xᵢ, yⱼ, u, v). Any number of light field display modules 760 may be disposed over a surface in one or two dimensions to create a 4D light field with any number of spatial coordinates (x, y).

For a system comprised of multiple waveguides disposed over an illumination plane, a 4D light field is comprised of all the 4D coordinates (x, y, u, v) for multiple waveguides at various spatial coordinates, each waveguide associated with multiple illumination source pixel (u, v) coordinates. FIG. 8A shows a light field system comprised of multiple waveguides 804 disposed over a display surface 811 defined by an illumination energy source plane 810 having energy source pixels such as 803. The light field display system in FIG. 8A is comprised of three light field display modules similar to 730 shown in FIG. 7A, but it may have any number of light field display modules. The display surface 811 may be the seamless display surface 620 in FIG. 6, the display area 505 of display device 501 shown in FIG. 5, or some other display surface. Disposed above the illumination plane 810 is a waveguide array 804 comprised of waveguides 704A, 704B, and 704C. The waveguides 704A, 704B, and 704C have the positional coordinates (x, y)=(0, y₀), (x, y)=(1, y₀), and (x, y)=(2, y₀), respectively. Associated with each waveguide 704A-C is a group of pixels 802A-C, respectively. The electromagnetic energy from each group of energy source pixels 802A-C is received by the corresponding waveguide and projected into a group of propagation paths 825A-C, respectively, each propagation path having a 2D angular (u, v) coordinate. For the first waveguide 704A, the chief rays 821, 822, and 823 define the propagation paths of light projected from the waveguide 704A at the minimum, mid-value, and maximum values of light field angular coordinate u, respectively. The light field angular coordinate v is orthogonal to u but is not shown in FIG. 8A. In FIG. 8A, the light-inhibiting structures 809 are vertical walls between neighboring waveguides 704A, 704B, and 704C and prevent light generated by one group of pixels associated with a first waveguide from reaching the neighboring waveguide. For example, light from any pixel 802B associated with the center waveguide 704B cannot reach waveguide 704A because of the light-inhibiting structure 809 between these two waveguides. The multiple light propagation paths 825A-C may converge to form holographic surfaces on either side of display surface 811. With a high enough density of source pixels such as 802A per waveguide 704A, and a large number of waveguides 804, the holographic surfaces may be viewed from multiple angles, and be perceived as virtually indistinguishable from one or more real-world objects. FIG. 8A shows one implementation of a light field display defined by an array of waveguides over an energy source plane. There are many other architectures possible, for example ones with holographic optical elements, and others comprised of beam-steering devices and collimated light sources that may include lasers and beam expanders.

FIG. 8B shows a portion of a light field display 820 comprised of an array 860 of multiple light field display modules like 760 in FIG. 7B, each light field display module associated with a single spatial coordinate and producing multiple energy propagation paths each with a unique 4D coordinate (x, y, u, v). Light field display modules 830, 840, and 850 in array 860 at spatial coordinates (x₁, y₁), (x₂, y₂), and (x₃, y₃) produce light propagation path groups 8300, 8400, and 8500, respectively. Light propagation paths 8300 all share spatial coordinate (x₁, y₁) and have the multiple angular coordinates (u₁₋₇, v₁₋₇). Light propagation paths 8400 all have spatial coordinate (x₂, y₂) and have the multiple angular coordinates (u₁₁₋₁₇, v₁₁₋₁₇), and light propagation paths 8500 all are assigned to the spatial coordinate (x₃, y₃) and have the multiple angular coordinates (u₂₁₋₂₇, v₂₁₋₂₇). The multiple light propagation paths 8300, 8400, and 8500 may converge to form holographic surfaces on either side of display surface 899. With a high enough density of propagation paths 8300, 8400, or 8500 per light field display module 830, 840, or 850, respectively, and a large number of light field display modules such as 830, 840, and 850, the holographic surfaces may be viewed from multiple angles, and be perceived as virtually indistinguishable from one or more real-world objects.

FIG. 9A shows the light field display system of FIG. 8A comprised of multiple waveguides 804 disposed over a display surface 811, where the center waveguide 704B is disposed over a boundary 916 formed by two different display devices 905A and 905B, and wherein the pixels on the right and left side of the boundary 916 are updated at different times. The numbering of FIG. 9A is used in FIG. 9A. Light from the source pixels on illumination plane 810 is received by the waveguides 704A-C and projected into one of many chief ray light propagation paths 825A-C, respectively. On the middle waveguide 704B, the propagation paths 825C may be divided into a first group of propagation paths 926 from pixels on display 905B on the right, and are updated by scan line 931 at a time t1, and second group of propagation paths 927 from pixels on the illumination plane 810 which come from a display 905A on the left, and are updated by a scan line 932 at time t2, where t1 and t2 may be separated in time by almost the period of time to refresh each display 905A or 905B. The timing shown in FIG. 9A may be the uniform scan sequence timing illustrated in FIG. 4A. An observer 980 may detect a video artifact because half of the light propagation paths 926 from waveguide 704B are updated at a different time than the other half of the light propagation paths 927 from the same waveguide. The fact that a temporal artifact exists at a spatial seam between displays may make the spatial seam more noticeable. Note that in this uniform scan sequence, the 4D light field propagation paths 825A and 825B from neighboring waveguides 704A and 704B, respectively, as well as propagation paths 825B and 825C from neighboring waveguides 704B and 704C, respectively, may not be updated all at the same time. In addition, the 4D light propagation paths 825A and 825C from waveguides 704A and 704C, respectively, on either side of a display boundary may be updated at substantially different times. This time difference may be about the video refresh period of the displays 905A and 905B.

FIG. 9B shows the light field display system shown in FIG. 9A, but wherein pixels on the right and left side of the boundary 916 formed by the two different display devices 905A and 905B are updated at the same time t1 by the left display scan 942 which meets the right display scan 941 at the boundary 916 simultaneously. An observer 980 will see all the propagation paths 926 and 927 from waveguide 704B updated at approximately the same moment, which eliminates the temporal artifact of FIG. 9A, and reduces the chance of an observer 980 seeing any discontinuity in pixel density around the location of the seam 916. FIG. 9B represents the butterfly scan shown for the tiled display in FIG. 4B, where the scan directions for displays on either side of seams 431, 433, and 435 start on the side opposite to the respective seam, and then moves toward the respective seam, finally meeting at the respective seam at substantially the same time.

FIG. 9C shows the light field display system shown in FIG. 9A, but wherein pixels on the right and left side of the boundary 916 formed by the two different display devices 905A and 905B are updated at the same time t1 by the left display scan 952 and the right display scan 951 which both start at the boundary 916 and move in opposite directions. An observer 980 will see all the propagation paths 926 and 927 from waveguide 704B updated at approximately the same moment, which eliminates the temporal artifact of FIG. 9A, and reduces the chance of an observer 980 seeing any discontinuity in pixel density around the location of the seam 916. FIG. 9C represents the butterfly scan shown for the tiled display in FIG. 4B, where the scan directions for displays on either side of seams 432 and 434 starts at the respective seam and then moves away from the respective seam. Note that in the butterfly scan sequences shown in FIGS. 9B and 9C, the 4D light field propagation paths 825A and 825B from neighboring waveguides 704A and 704B, respectively, as well as propagation paths 825B and 825C from neighboring waveguides 704B and 704C, respectively, may be updated all at the same time. In addition, the 4D light propagation paths 825A and 825C from waveguides 704A and 704C, respectively, on either side of a display boundary may be updated at substantially the same time.

FIG. 10A is a top view of a portion of a light field display system comprised of an array of light field display modules 860 arranged into two groups 1076 and 1077. The light field display modules 860 may be the same as the display module 760 shown in FIG. 7B. In another embodiment, the light field display modules 806 may be like waveguides 804 in FIG. 8A disposed over an illumination plane 810 formed by multiple displays 1076 and 1077. In a different embodiment, the light field display modules 860 may be those shown in FIG. 8B, wherein the groups 1076 and 1077 represent a grouping of drive electronics or control modules which update the corresponding light field display units 806 sequentially. The two groups 1076 and 1077 may be updated in a scan sequence like the scan sequences shown in FIGS. 2A and 2B for displays 201A and 201B, and the scan sequences may be customized to a particular application.

FIG. 10B is a side view of the light field display system shown in FIG. 10A, showing three possible scan sequences 1070, 1080, and 1090 for groups 1076 and 1077 of light field modules 806, and an expanded view 820 of three of the light field display modules 860 near the middle boundary 1072 between the two groups 1076 and 1077. The closeup 820 is the same portion of a light field display shown in FIG. 8B, and the numbering of FIG. 8B is used in 820. The first group 1076 of light field display modules 860 lies between boundaries 1061 and 1062, while the second group 1077 of light field display modules 860 lies between boundaries 1062 and 1063. The groups 1076 and 1077 may be updated in a first sequence 1070 where the modules in both groups 1076 and 1077 are updated by scans 1071 and 1072 respectively from left to right; updated in a second sequence 1080 where the modules in the left group 1076 are updated by scan 1081 from left to right while the modules in right group 1077 are updated by scan 1082 in the opposite direction, from right to left and meeting at common boundary 1062 at the same time; or updated in a third sequence 1090 where the modules in the left group 1076 are updated from right to left 1091 away from common boundary 1062 and simultaneously the modules in the right group 1077 are updated from left to right 1092 also away from the common boundary 1062 and in the opposite direction. The first sequence 1070 corresponds to the uniform sequence shown in FIG. 4A, where the light field display modules 830 and 840 on either side of the boundary 1062 between the groups 1076 and 1077 are updated at different times. This may cause noticeable temporal artifacts to an observer. The second sequence 1080 in which the scans 1081 and 1082 meet at the boundary 1062 at the same time corresponds to the butterfly sequence shown in FIG. 4B, particularly at seams 431, 433, and 435. The third sequence 1090 in which the scans 1091 and 1092 start at the common boundary 1062 at the same time and head in opposite directions corresponds to the butterfly sequence shown in FIG. 4B, particularly at seams 432 and 434. In the butterfly scan sequences 1080 and 1099, all neighboring light field display modules are updated at the same time, even for light field modules 830 and 840 on either side of boundary 1062, and this may eliminate temporal artifacts that would be present if a normal uniform scanning technique shown in FIG. 4A were used on light field display modules in groups 1076 and 1077.

What is claimed is:

1. A method of scanning an array of display devices with image content, wherein a full resolution of the image content is divided among the displays, the method comprising:
updating a first display device of the array of display devices in a first update direction, wherein updating the first display device begins at a first scan line, l_{1,1}, and ends at an n^{th} scan line, l_{1,n}, of the first display device; and
updating a second display device of the array of display devices in a second update direction opposite the first update direction, wherein updating the second display device begins at a first scan line, l_{2,1}, and ends at an n^{th} scan line, l_{2,n}, of the second display device; and
wherein the first and second display devices are adjacent to each other and form a seam therebetween.

2. The method of claim 1, wherein updating the first display device comprises updating in the first direction towards the seam and updating the second display device comprises updating in the second update direction towards the seam.

3. The method of claim 2, wherein the first scan line, l_{1,1}, and n^{th} scan line, l_{1,n}, of the first display device comprise a top horizontal scan line and a bottom horizontal scan line of the first display device, respectively;
wherein the first scan line, l_{2,1}, and n^{th} scan line, l_{2,n}, of the second display device comprise a bottom horizontal scan line and a top horizontal scan line of the second display device, respectively; and
wherein, the first display device is located above the second display device, and the n^{th} scan lines l_{1,n}, and l_{2,n} of the first and second display devices, respectively, are located adjacent to the seam between the first and second display devices and are updated at substantially the same time.

4. The method of claim 2, wherein the first scan line, l_{1,1}, and n^{th} scan line, l_{1,n}, of the first display device comprise a left-edge vertical scan line and a right-edge vertical scan line of the first display device, respectively;
wherein the first scan line, l_{2,1}, and n^{th} scan line, l_{2,n}, of the second display device comprise a right-edge vertical scan line and a left-edge vertical scan line of the second display device, respectively; and
wherein the n^{th} scan lines l_{1,n} and l_{2,n} of the first and second display devices, respectively, are located adjacent to the seam between the first and second display devices and updated at substantially the same time.

5. The method of claim 1, wherein updating the first display device comprises updating in the first direction away from the seam and updating the second display device comprises updating in the second update direction away from the seam.

6. The method of claim 5, wherein the first scan line, l_{1,1}, and n^{th} scan line, l_{1,n}, of the first display device comprise a top horizontal scan line and a bottom horizontal scan line of the first display device, respectively;
wherein the first scan line, l_{2,1}, and n^{th} scan line, l_{2,n}, of the second display device comprise a bottom horizontal scan line and a top horizontal scan line of the second display device, respectively; and
wherein the second display device is located above the first display device, and the first scan lines l_{1,1} and l_{2,1} of the first and second display devices, respectively, are located adjacent to the seam between the first and second display devices and updated at substantially the same time.

7. The method of claim 5, wherein the first scan line, l_{1,1}, and n^{th} scan line, l_{1,n} of the first display device comprise a left-edge vertical scan line and a right-edge vertical scan line of the first display device, respectively;
wherein the first scan line, l_{2,1}, and n^{th} scan line, l_{2,n}, of the second display device comprise a right-edge vertical scan line and a left-edge vertical scan line of the second display device, respectively; and
wherein the first scan lines l_{1,1} and l_{2,1} of the first and second display devices, respectively, are located adjacent to the seam between the first and second display devices and addressed at substantially the same time.

8. The method of claim 1, wherein the first display device is arranged to be located in a first column of the array of display devices, and the second display device is arranged to be located in a second column of the array of display devices, and further wherein the first column of the array of display devices comprises first additional display devices and the second column of the array of display devices comprises second additional display devices, each pair of adjacent display devices in the first and second columns forms a corresponding seam therebetween, and the method further comprises:
updating the first additional display devices in the same first update direction; and
updating the second additional display devices in the same second update direction.

9. The method of claim 8, wherein updating the first additional display devices comprises updating in the same first direction towards the corresponding seams and updating the second additional display devices comprises updating in the same second update direction towards the corresponding seams.

10. The method of claim 8, wherein updating the first additional display devices comprises updating in the same first direction away from the corresponding seams and updating the second additional display devices comprises updating in the same second update direction away from the corresponding seams.

11. The method of claim 1, wherein the first display device is arranged to be located in a first row of the array of display devices, and the second display device is arranged to be located in a second row of the array of display devices, and further wherein the first row of the array of display devices comprises first additional display devices and the second row of the array of display devices comprises second additional display devices, each pair of adjacent display devices in the first and second rows forms a corresponding seam therebetween, and the method further comprises:
updating the first additional display devices in the same first update direction; and
updating the second additional display devices in the same second update direction.

12. The method of claim 11, wherein updating the first additional display devices comprises updating in the first direction towards the corresponding seams and updating the second additional display devices comprises updating in the second update direction towards the corresponding seams.

13. The method of claim 11, wherein updating the first additional display devices comprises updating in the first direction away from the corresponding seams and updating the second additional display devices comprises updating in the second update direction away from the corresponding seams.

14. The method of claim 1, wherein the first and second display devices comprise two-dimensional displays, stereoscopic displays, autostereoscopic displays, or lenticular multi-view displays.

15. The method of claim 1, wherein the first display device comprises a first relayed display assembly, the first relayed display assembly comprising a first display surface and a first relay having a first end proximate the first display surface and a second end operable to provide a relayed display surface; and wherein the second display device comprises a second relayed display assembly, the second relayed display assembly comprising a second display surface and a second relay having a first end proximate the second display surface and a second end operable to provide a relayed display surface adjacent to the relayed display surface of the first relay.

16. The method of claim 15, wherein updating the first display device comprises updating the first display surface in the first update direction, thereby updating the relayed display surface of the first relay in a first mapped scan direction that is substantially the same as the first update direction; and wherein the updating the second display device comprises updating the second display surface in the second update direction, thereby updating the relayed display surface of the second relay in a second mapped scan direction that is substantially the same as the second update direction and opposite the first update direction.

17. The method of claim 1, wherein a light field display system comprises the array of display devices and a plurality of waveguides positioned over the array of display devices, and further wherein the seam formed by the first and second display devices of the array of display devices is located under a first waveguide of the plurality of waveguides, whereby, updating the first and second display devices updates light propagation paths through the first waveguide at the substantially the same time.

18. The method of claim 17, wherein a second waveguide is disposed over the first display device, and a third waveguide is disposed over the second display device, the second and third waveguides being adjacent to the first waveguide, wherein updating the first display device further updates light propagation paths through the second waveguide at substantially the same time as the time the light propagation paths are updated through the first waveguide, and updating the second display device further updates light propagation paths through the third waveguide at substantially the same time as the time the light propagation paths are updated through the first waveguide.

19. A display system comprising
an array of display devices operable to provide image content, wherein a full resolution of the image content is divided among the displays; and
a controller in electronic communication with the array of display devices, wherein the controller is programmed to:
update a first display device of the array of display devices in a first update direction, wherein the first display device is updated beginning at a first scan line, l_{1,1}, and ending at an n^{th} scan line, l_{1,n}, of the first display device; and
update a second display device of the array of display devices in a second update direction opposite the first update direction, the second display device is updated beginning at a first scan line, l_{2,1}, and ending at an n^{th} scan line, l_{2,n}, of the second display device; and
wherein the first and second display devices are adjacent to each other and form a seam therebetween.

20. The display system of claim 19, wherein the controller is programmed to update the first display device in the first direction towards the seam and update the second display device in the second update direction towards the seam.

21. The display system of claim 20, wherein the first scan line, l_{1,1}, and n^{th} scan line, l_{1,n}, of the first display device comprise a top horizontal scan line and a bottom horizontal scan line of the first display device, respectively;
wherein the first scan line, l_{2,1}, and n^{th} scan line, l_{2,n}, of the second display device comprise a bottom horizontal scan line and a top horizontal scan line of the second display device, respectively; and
wherein, the first display device is located above the second display device, and the n^{th} scan lines l_{1,n} and l_{2,n} of the first and second display devices, respectively, are located adjacent to the seam between the first and second display devices and updated at substantially the same time.

22. The display system of claim 20, wherein the first scan line, l_{1,1}, and n^{th} scan line, l_{1,n}, of the first display device comprise a left-edge vertical scan line and a right-edge vertical scan line of the first display device, respectively;
wherein the first scan line, l_{2,1}, and n^{th} scan line, l_{2,n}, of the second display device comprise a right-edge vertical scan line and a left-edge vertical scan line of the second display device, respectively; and
wherein the n^{th} scan lines l_{1,n} and l_{2,n} of the first and second display devices, respectively, are located adjacent to the seam between the first and second display devices and are updated at substantially the same time.

23. The display system of claim 19, wherein the controller is programmed to update the first display device in the first direction away from the seam and update the second display device in the second update direction away from the seam.

24. The display system of claim 23, wherein the first scan line, l_{1,1}, and n^{th} scan line, l_{1,n} of the first display device comprise a top horizontal scan line and a bottom horizontal scan line of the first display device, respectively;
wherein the first scan line, l_{2,1}, and n^{th} scan line, l_{2,n}, of the second display device comprise a bottom horizontal scan line and a top horizontal scan line of the second display device, respectively; and
wherein the second display device is located above the first display device, and the first scan lines l_{1,1} and l_{2,1} of the first and second display devices, respectively, are located adjacent to the seam between the first and second display devices and updated at substantially the same time.

25. The display system of claim 23, wherein the first scan line, l_{1,1}, and n^{th} scan line, l_{1,n} of the first display device comprise a left-edge vertical scan line and a right-edge vertical scan line of the first display device, respectively;
wherein the first scan line, l_{2,1}, and n^{th} scan line, l_{2,n}, of the second display device comprise a right-edge vertical scan line and a left-edge vertical scan line of the second display device, respectively; and
wherein the first scan lines l_{1,1} and l_{2,1} of the first and second display devices, respectively, are located adjacent to the seam between the first and second display devices and addressed at substantially the same time.

26. The display system of claim 19, wherein the first display device is arranged to be located in a first column of the array of display devices, and the second display device is arranged to be located in a second column of the array of display devices, and further wherein the first column of the array of display devices comprises first additional display devices and the second column of the array of display devices comprises second additional display devices, each pair of adjacent display devices in the first and second columns forms a corresponding seam therebetween, and the controller is further programmed to:
update the first additional display devices in the same first update direction; and
update the second additional display devices in the same second update direction.

27. The display system of claim 26, wherein the controller is programmed to update the first additional display devices in the same first direction towards the corresponding seams and update the second additional display devices in the same second update direction towards the corresponding seams.

28. The display system of claim 26, wherein the controller is programmed to update the first additional display devices in the same first direction away from the corresponding seams and update the second additional display devices in the same second update direction away from the corresponding seams.

29. The display system of claim 19, wherein the first display device is arranged to be located in a first row of the array of display devices, and the second display device is arranged to be located in a second row of the array of display devices, and further wherein the first row of the array of display devices comprises first additional display devices and the second row of the array of display devices comprises second additional display devices, each pair of adjacent display devices in the first and second rows form a corresponding seam therebetween, and the controller is further programmed to:
update the first additional display devices in the same first update direction; and
update the second additional display devices in the same second update direction.

30. The display system of claim 29, wherein the controller is programmed to update the first additional display devices in the same first direction towards the corresponding seams and update the second additional display devices in the same second update direction towards the corresponding seams.

31. The display system of claim 29, wherein the controller is programmed to update the first additional display devices in the same first direction away from the corresponding seams and update the second additional display devices in the same second update direction away from the corresponding seams.

32. The display system of claim 29, wherein the first and second display devices comprise two-dimensional displays, stereoscopic displays, autostereoscopic displays, or lenticular multi-view displays.

33. The display system of claim 19, wherein the first display device comprises a first relayed display assembly, the first relayed display assembly comprising a first display surface and a first relay having a first end proximate the first display surface and a second end operable to provide a relayed display surface; and wherein the second display device comprises a second relayed display assembly, the second relayed display assembly comprising a second display surface and a second relay having a first end proximate the second display surface and a second end operable to provide a relayed display surface adjacent to the relayed display surface of the first relay.

34. The display system of claim 33, wherein the controller is programmed to update the first display device by updating the first display surface in the first update direction, thereby updating the relayed display surface of the first relay in a first mapped scan direction that is substantially the same as the first update direction; and wherein the controller is programmed to update the second display device by updating the second display surface in the second update direction, thereby updating the relayed display surface of the second relay in a second mapped scan direction that is substantially the same as the second update direction and opposite the first update direction.

35. The display system of claim 19, wherein the display system is a light field display system comprised of the array of display devices and a plurality of waveguides positioned over the array of display devices, and further wherein the seam formed by the first and second display devices of the array of display devices is located under a first waveguide of the plurality of waveguides, wherein, the controller is programmed to update the first and second display devices such that light propagation paths through the first waveguide are updated at the substantially the same time.

36. The display system of claim 35, wherein a second waveguide is disposed over the first display device, and a third waveguide is disposed over the second display device, the second and third waveguides being adjacent to the first waveguide, wherein the controller is programmed to update the first display device such that light propagation paths through the second waveguide are updated at substantially the same time as the time the light propagation paths are updated through the first waveguide, and update the second device such that light propagation paths through the third waveguide are updated at substantially the same time as the time the light propagation paths are updated through the first waveguide.

37. A controller programmed for scanning an array of display devices with image content, wherein a full resolution of the image content is divided among the displays, the controller configured to:
update a first display device of the array of display devices in a first update direction, wherein the first display device is updated beginning at a first scan line, l_{1,1}, and ending at an n^{th} scan line, l_{1,n}, of the first display device; and
update a second display device of the array of display devices in a second update direction opposite the first update direction, the second display device is updated beginning at a first scan line, l_{2,1}, and ending at an n^{th} scan line, l_{2,n}, of the second display device; and
wherein the first and second display devices are adjacent to each other and form a seam therebetween.

38. The controller of claim 37, wherein the controller is programmed to update the first display device in the first direction towards the seam and update the second display device in the second update direction towards the seam.

39. The controller of claim 38, wherein the first scan line, l_{1,1}, and n^{th} scan line, l_{1,n}, of the first display device comprise a top horizontal scan line and a bottom horizontal scan line of the first display device, respectively;
wherein the first scan line, l_{2,1}, and n^{th} scan line, l_{2,n}, of the second display device comprise a bottom horizontal scan line and a top horizontal scan line of the second display device, respectively; and
wherein, the first display device is located above the second display device, and the n^{th} scan lines l_{1,n} and l_{2,n} of the first and second display devices, respectively, are located adjacent to the seam between the first and second display devices and the controller is programmed to update the n^{th} scan lines l_{1,n} and l_{2,n} at substantially the same time.

40. The controller of claim 38, wherein the first scan line, l_{1,1}, and n^{th} scan line, l_{1,n}, of the first display device comprise a left-edge vertical scan line and a right-edge vertical scan line of the first display device, respectively;
wherein the first scan line, l_{2,1}, and n^{th} scan line, l_{2,n}, of the second display device comprise a right-edge vertical scan line and a left-edge vertical scan line of the second display device, respectively; and
wherein the n^{th} scan lines l_{1,n} and l_{2,n} of the first and second display devices, respectively, are located adjacent to the seam between the first and second display devices and the controller is programmed to update the n^{th} scan lines l_{1,n} and l_{2,n} at substantially the same time.

41. The controller of claim 37, wherein the controller is programmed to update the first display device in the first direction away from the seam and update the second display device in the second update direction away from the seam.

42. The controller of claim 41, wherein the first scan line, l_{1,1}, and n^{th} scan line, l_{1,n} of the first display device comprise a top horizontal scan line and a bottom horizontal scan line of the first display device, respectively;
wherein the first scan line, l_{2,1}, and n^{th} scan line, l_{2,n}, of the second display device comprise a bottom horizontal scan line and a top horizontal scan line of the second display device, respectively; and
wherein the second display device is located above the first display device, and the first scan lines l_{1,1} and l_{2,1} of the first and second display devices, respectively, are located adjacent to the seam between the first and second display devices and the controller is programmed to update the first scan lines l_{1,1} and l_{2,1} at substantially the same time.

43. The controller of claim 41, wherein the first scan line, l_{1,1}, and n^{th} scan line, l_{1,n} of the first display device comprise a left-edge vertical scan line and a right-edge vertical scan line of the first display device, respectively;
wherein the first scan line, l_{2,1}, and n^{th} scan line, l_{2,n}, of the second display device comprise a right-edge vertical scan line and a left-edge vertical scan line of the second display device, respectively; and
wherein the first scan lines l_{1,1} and l_{2,1} of the first and second display devices, respectively, are located adjacent to the seam between the first and second display devices and the controller is programmed to update the first scan lines l_{1,1} and l_{2,1} at substantially the same time.

44. The controller of claim 37, wherein the first display device is arranged to be located in a first column of the array of display devices, and the second display device is arranged to be located in a second column of the array of display devices, and further wherein the first column of the array of display devices comprises first additional display devices and the second column of the array of display devices comprises second additional display devices, each pair of adjacent display devices in the first and second columns form a corresponding seam therebetween, and the controller is further programmed to:
update the first additional display devices in the same first update direction; and
update the second additional display devices in the same second update direction.

45. The controller of claim 44, wherein the controller is programmed to update the first additional display devices in the same first direction towards the corresponding seams and update the second additional display devices in the same second update direction towards the corresponding seams.

46. The controller of claim 44, wherein the controller is programmed to update the first additional display devices the same first direction away from the corresponding seams and update the second additional display devices in the same second update direction away from the corresponding seams.

47. The controller of claim 37, wherein the first display device is arranged to be located in a first row of the array of display devices, and the second display device is arranged to be located in a second row of the array of display devices, and further wherein the first row of the array of display devices comprises first additional display devices and the second row of the array of display devices comprises second additional display devices, each pair of adjacent display devices in the first and second rows form a corresponding seam therebetween, and the controller is further programmed to:
update the first additional display devices in the same first update direction; and
update the second additional display devices in the same second update direction.

48. The controller of claim 47, wherein the controller is programmed to update the first additional display devices in the same first direction towards the corresponding seams and update the second additional display devices in the same second update direction towards the corresponding seams.

49. The controller of claim 47, wherein the controller is programmed to update the first additional display devices in the same first direction away from the corresponding seams and update the second additional display devices in the same second update direction away from the corresponding seams.

50. The controller system of claim 37, wherein the first and second display devices comprise two-dimensional displays, stereoscopic displays, autostereoscopic displays, or lenticular multi-view displays.

51. The controller of claim 37, wherein the first display device comprises a first relayed display assembly, the first relayed display assembly comprising a first display surface and a first relay having a first end proximate the first display surface and a second end operable to provide a relayed display surface; and wherein the second display device comprises a second relayed display assembly, the second relayed display assembly comprising a second display surface and a second relay having a first end proximate the second display surface and a second end operable to provide a relayed display surface adjacent to the relayed display surface of the first relay.

52. The controller of claim 51, wherein the controller is programmed to update the first display device by updating the first display surface in the first update direction, thereby updating the relayed display surface of the first relay in a first mapped scan direction that is substantially the same as the first update direction; and wherein the controller is programmed to update the second display device by updating the second display surface in the second update direction, thereby updating the relayed display surface of the second relay in a second mapped scan direction that is substantially the same as the second update direction and opposite the first update direction.

53. The controller of claim 37, wherein a light field display system comprises a plurality of waveguides positioned over the array of display devices, and further wherein the seam formed by the first and second display devices of the array of display devices is located under a first waveguide of the plurality of waveguides, wherein, the controller is programmed to update the first and second display devices such that light propagation paths through the first waveguide are updated at the substantially the same time.

54. The controller of claim 53, wherein a second waveguide is disposed over the first display device, and a third waveguide is disposed over the second display device, the second and third waveguides being adjacent to the first waveguide, wherein the controller is programmed to update the first display device such that light propagation paths through the second waveguide are updated at substantially the same time as the time the light propagation paths are updated through the first waveguide, and update the second device such that light propagation paths through the third waveguide are updated at substantially the same time as the time the light propagation paths are updated through the first waveguide.

55. A method of scanning a light field display system, the system comprising a plurality of groups of light field units, wherein the light field units are each configured to project light along a plurality of light propagation paths, each light propagation path having a set of two spatial coordinates and two angular coordinates in a first four-dimensional coordinate system, the two spatial coordinates defined by the position of the respective light field unit; the method comprising:
updating a first group of light field units in a first update direction; and
updating a second group of the light field units in a second update direction opposite the first update direction; and
wherein the first and second groups of light field units are adjacent to each other and form a boundary therebetween.

56. The method of claim 55, wherein updating the first group of light field units comprises updating in the first update direction towards the boundary and updating the second group of light field units comprises updating in the second update direction towards the boundary.

57. The method of claim 55, wherein updating the first group of light field units comprises updating in the first update direction away from the boundary and updating the second group of light field units comprises updating in the second update direction away from the boundary.

58. The method of claim 55, wherein the first update direction is a left-to-right direction, and the second update direction is a right-to-left direction.

59. The method of claim 55, wherein the first update direction is a top-to-bottom direction, and the second update direction is a bottom-to-top direction.

60. The method of claim 55, wherein the neighboring light field units on either side of the boundary are updated at substantially the same time.

61. A light field display system comprising
a plurality of groups of light field units, wherein the light field units are each configured to project light along a plurality of light propagation paths, each light propagation path having a set of two spatial coordinates and two angular coordinates in a first four-dimensional coordinate system, the two spatial coordinates defined by the position of the respective light field unit; and
a controller in electronic communication with the light field units, wherein the controller is programmed to:
update a first group of light field units in a first update direction; and
update a second group of the light field units in a second update direction opposite the first update direction; and
wherein the first and second groups of light field units are adjacent to each other and form a boundary therebetween.

62. The system of claim 61, wherein the controller is programed to update the first group of light field units in the first update direction towards the boundary and update the second group of light field units in the second update direction towards the boundary.

63. The system of claim 61, wherein the controller is programed to update the first group of light field units in the first update direction away from the boundary and update the second group of light field units in the second update direction away from the boundary.

64. The system of claim 61, wherein the first update direction is a left-to-right direction, and the second update direction is a right-to-left direction.

65. The system of claim 61, wherein the first update direction is a top-to-bottom direction, and the second update direction is a bottom-to-top direction.

66. The system of claim 61, wherein the controller is programmed to update the first and second groups of light field units such that the neighboring light field units on either side of the boundary are updated at substantially the same time.

67. A controller programmed for scanning a light field display system, the system comprising a plurality of groups of light field units, wherein the light field units are each configured to project light along a plurality of light propagation paths, each light propagation path having a set of two spatial coordinates and two angular coordinates in a first four-dimensional coordinate system, the spatial coordinates defined by the position of the respective light field unit, the controller configured to:
update a first group of light field units in a first update direction; and
update a second group of the light field units in a second update direction opposite the first update direction; and
wherein the first and second groups of light field units are adjacent to each other and form a boundary therebetween.

68. The controller of claim 67, wherein the controller is programed to update the first group of light field units in the first update direction towards the boundary and update the second group of light field units in the second update direction towards the boundary.

69. The controller of claim 67, wherein the controller is programed to update the first group of light field units in the first update direction away from the boundary and update the second group of light field units in the second update direction away from the boundary.

70. The controller of claim 67, wherein the first update direction is a left-to-right direction, and the second update direction is a right-to-left direction.

71. The controller of claim 67, wherein the first update direction is a top-to-bottom direction, and the second update direction is a bottom-to-top direction.

72. The controller of claim 67, wherein the controller is programmed to update the first and second groups of light field units such that the neighboring light field units on either side of the boundary are updated at substantially the same time.
